(19) United States
(12) Patent Application Publication
(10) Pub. No.: US 2016/0229160 A1
(43) Pub. Date: Aug. 11, 2016

(54) POLYVINYLIDENE CHLORIDE COATED SUBSTRATES

(71) Applicant: Innovia Films Limited, Cumbria (GB)

(72) Inventors: Christopher KONKEL, Wigton, Cumbria (GB); David TAYLOR, Wigton, Cumbria (GB); Colin MARSHALL, Wigton, Cumbria (GB)

(21) Appl. No.: 15/021,901

(22) PCT Filed: Oct. 17, 2014
(86) PCT No.: PCT/GB2014/053124

§ 371 Date: Mar. 14, 2016

(30) Foreign Application Priority Data
Oct. 18, 2013 (GB) 1318491.6

(51) Int. Cl. B32B 27/30; B32B 23/08; B05D 7/04; B32B 27/32; B32B 27/36; B05D 1/26; B32B 27/08; B32B 27/18

(52) U.S. Cl. CPC B32B 27/304; B32B 27/08; B32B 23/08; B32B 27/18; B32B 27/32; B32B 27/36; B05D 1/265; B05D 7/04; B32B 2307/7246; B32B 2439/70

(57) ABSTRACT

The present invention concerns a coated substrate comprising a substrate and an extrusion coated PVdC layer with a thickness of less than 10 micrometres.

The present invention relates to substrates which are coated with polyvinylidene chloride (PVdC) materials, and methods for preparing such products. In particular, the present invention relates to films which are extrusion coated with PVdC.

PVdC is a material which is produced from vinylidene chloride monomer, together with smaller quantities of other comonomers and optionally containing various additives.

PVdC is used for a variety of applications. One of its most common uses is as a coating on another polymeric film or other substrate. It exhibits excellent barrier properties against moisture and gases, and imparts heat sealability and printability with good gloss and transparency, thereby making it particularly useful for the packaging of food and other products.

PVdC coatings can be applied via solvent-based lacquers, aqueous latexes or via thick encapsulated (coextruded) extrusion layers.

Solvent coating methods, for example traditional dip-tank and doctor roller coating methods, give good results. However, it is preferable to avoid the use of solvents, for cost and environmental reasons, and to simplify the process and reduce disposal burdens.

Aqueous coating methods can avoid the use of organic solvents but can produce inferior products, particularly where substrates are water-sensitive and especially where properties such as appearance and transparency can be affected. For example, coating E167 (a cellulose film available from Innovia Films Limited) with PVdC latex can result in a poor web profile, a poor appearance, and edge curl problems.

There have also been disclosures of applying PVdC layers by extrusion coating. For example, WO 98/52737 discloses the extrusion coating of a layer of PVdC having a thickness of at least 10 micrometres on a substrate.

PVdC is susceptible to degradation during extrusion and degradation is autocatalytic, with the result that once degradation starts it can propagate quite quickly resulting in decomposition of the material. WO 98/52737 seeks to mitigate these problems by having shortened flow passages during the extrusion process, coating the flow passages with polyethylene, and using a die made of a highly corrosion resistant material (e.g. high-nickel alloy steel) to inhibit the degradation of PVdC. According to WO 98/52737, this minimises residence time and delays the autocatalytic process starting at the peripheries.

WO 98/52737 discloses that the substrate is coated with a primer layer, or is subjected to corona treatment and ozone treatment, prior to extrusion coating with PVdC. The document teaches that this allows the extrusion process to be carried out at a lower temperature whilst still achieving acceptable adherence.

WO 98/52737 further discloses that the temperature of extrusion of PVdC needs to be tightly controlled (and in this context refers to approximately 170° C.) to avoid rapid degradation.

Full or partial encapsulation of the PVdC within other layers prior to extrusion can bring advantages. WO 98/52737 utilises an encapsulating adhesive layer which exhibits lower adherence to extrusion apparatus, lower viscosity and better temperature stability.

In contrast the present invention avoids the encapsulation of PVdC because the use of extra polymer layers (e.g. to shield the PVdC and/or alter the processability) adds cost, thickness and complexity. The present invention is particularly concerned with providing a solution which is simple and cost-effective and which avoids unnecessary materials and process steps.

U.S. Pat. No. 3,741,253 discloses a three-ply laminate wherein a ply having a thickness of 0.05 to 2 mils (1.3 to 51 μm) comprising a polymer of vinylidene chloride and vinyl chloride is sandwiched between plies comprising polymers of ethylene and vinyl acetate. The central ply provides barrier properties and an outer ply provides strength, for example to resist puncture by bone-in meat products. The product is made by melt extruding one ply as a tubular film, solidifying and cross-linking this material, passing it to a coating die wherein what becomes the middle ply is melt extruded as a second tubular film, coated on and directly adhered to the first tube, and the two-ply tubular film is then passed to a further coating die, preferably while still hot, so that the remaining ply is then extruded as a further tubular film coated on and directly adhered to the two-ply material to form a three-ply tubular film laminate. The three ply tubular film is then solidified, stretched and biaxially oriented. The document refers to the barrier ply being part suspension polymer and part emulsion polymer and preferably including other materials such as epoxy resin. The document teaches that extrusion of the barrier ply is effective because of the particular blend used.

As disclosed in WO 2012/137014, one category of useful films is that which provides biodegradable and yet effective barrier and/or sealing properties. The present invention envisages the use of various substrates, including those which are biodegradable or compostable, e.g. cellulosic substrates, such as those disclosed in WO 2012/137014. In particular, the substrate of the present invention may preferably comprise a cast film (rather than a co-extruded layer). However, WO 2014/137014 does not disclose the extrusion coating of PVdC, but rather polyester and/or co-polyester and/or starch and/or starch-based coatings.

U.S. Pat. No. 5,788,902 and U.S. Pat. No. 6,116,885 are further documents which disclose encapsulation of degradable materials such as PVdC with non-degradable plastic materials to facilitate extrusion. These documents relate to particular arrangements of extrusion apparatus to achieve effective encapsulation. However, as noted above, the present invention seeks to avoid encapsulation because encapsulation adds complexity and cost and requires the presence of additional layers in the product.

US 2013/0147086 recognizes that PVdC can decompose during extrusion and that decomposition occurs more quickly when the PVdC is in contact with the surfaces of the extrusion apparatus. The solution proposed by this document is to add a small amount of finely ground polyethylene to PVdC prior to extrusion. The document teaches that the polyethylene melts before the PVdC and encapsulates the PVdC thereby preventing contact between the PVdC and the metal of the extrusion apparatus.

WO 2007/012805 discloses a thin layer (0.01 to 6 micrometres) comprising PVdC on a substrate. However, the layer comprising PVdC is a primer layer between the substrate and a heat sealable polymeric layer. In contrast the PVdC coating in the present invention is used for its barrier properties and/or other properties e.g. sealability and/or printability. Various methods of coating are theoretically suggested, but there is no indication of how these techniques would be applied to PVdC, or what state (e.g. aqueous dispersion, solvent dispersion) the PVdC would be required to have. Whilst WO 2007/012805 mentions that the primer composition may be applied using any suitable coating technique “including gravure roll coating (direct or indirect), forward or reverse roll coating, slot-die coating, dip coating, bead coating, extrusion-coating, melt-coating or electrostatic spray coating”, the focus of this document is nevertheless on application of the primer layer to the substrate by coating solution, and all of the examples disclose coating from solution.

A commercial PVdC extrusion coating apparatus is available from Macro Engineering & Technology Inc. (Ontario, Canada). Their product information documents recognize the issues discussed above (the advantages of temperature control, low residence time, use of high nickel alloy steel in the extrusion apparatus, and application of primer to the substrate). “Macroletter”, Volume 4 Issue 1, Winter 1998 Special Edition, Macro Engineering & Technology Inc., teaches that PVdC can be applied at a thickness of 20 to 250 microns, advantageously 35 microns or more, and www.macroeng.com/pvdc-extrusion-coating.php (accessed on 4 Oct. 2013) specifies a thickness of 20 to 250 microns.

We have now found that it is possible to provide PVdC extrusion coatings which are thinner than those disclosed in the prior art, and which provide good barrier and/or sealing properties.

From a first aspect the present invention provides a substrate having an extrusion coated PVdC layer with a thickness of less than 10 micrometres.

From a second aspect the present invention provides a process for producing a coated substrate comprising providing a substrate and applying a PVdC coating to the substrate by an extrusion coating step wherein the PVdC layer has a thickness of less than 10 micrometres.

The PVdC layer is preferably an outer layer, i.e. whilst the substrate is on one side of the PVdC layer, there is no further layer, or at least no co-extruded layer, on the other side of the PVdC layer. Nevertheless the PVdC layer may be printed or marked.

Extrusion coating imparts particular characteristics to a PVdC layer such that it has different characteristics to a PVdC layer made by other processes. It provides a smooth coating free of solvent residues which are a feature of solvent coating and free of surfactant residues which are a feature of latex coating. It allows a greater range of thicknesses to be obtained than those provided by solvent and aqueous coating methods. No drying is required, thereby saving energy and improving the carbon footprint.

The thin PVdC coating is advantageous as it reduces the amount of material required which eases the manufacturing process, lowers the cost, reduces waste and eases disposal or recycling. At the same time, the thin coating is sufficiently uniform and exhibits good barrier, sealing, and visual properties. In contrast, the prior art has previously taught towards the use of thicker coatings.

The PVdC layer may optionally be even thinner, e.g. less than any of 9, 8, 7, 6, 5, 4, 3 or 2 micrometres, for example between 1 and 5 micrometres.

In the present invention the substrate is already pre-formed before being extrusion coated with PVdC. The substrate preferably comprises a cast film, e.g. a cast regenerated cellulose film. Other examples of possible substrates include PP, OPP, PET, PA, BOPA, BOPP, PLA, BOPLA, polystyrene or BOPET films.

PVdC is a polymer made from vinylidene chloride monomers. Commercially, it is most commonly available as a copolymer, i.e. is usually made from not only vinylidene chloride monomers but also other monomers e.g. vinyl chloride and/or methyl acrylate. PVdC products are available in some countries under the trade name “Saran”.

In the present invention, the PVdC may for example be one of (i) a copolymer of vinylidene chloride and vinyl chloride; (ii) a copolymer of vinylidene chloride and methyl acrylate; or (iii) a copolymer of vinylidene chloride, vinyl chloride and methyl acrylate. Optionally, other monomers may additionally or alternatively be used, for example other acrylic acids or esters. Additives may also be used.

We have found that thin yet effective coatings can be achieved by controlling the viscosity of the PVdC blends. The viscosity needs to be high enough so that the melt curtain is stable and so that a uniform coating is produced without holes, tears or inhomogeneities. Nevertheless, excessive viscosity can result in extrusion difficulties due to the pressures required if the flowability is too low.

As referred to herein, relative viscosity is the ratio of the viscosity of a 1% solution (measured at 1% solids in THF at 20 degrees C.) to the viscosity of the solvent. In some embodiments the relative viscosity may be approximately 1.45 or lower, or approximately 1.4 or lower. Nevertheless, other viscosities may be used so long as they allow the formation of a sufficiently strong or stable melt curtain and an effective thin coating.

In accordance with the present invention, polymer blends may be chosen which combine appropriate viscosity properties with good melt curtain strength properties. As shown in the experiments summarized herein, surprisingly it is possible to balance the properties and achieve effective thin coatings. High draw and low thickness is possible. The viscosity is preferably low whilst still maintaining a stable melt curtain which survives the coating/draw.

Preferably the substrate is a film

Preferably the film is a packaging film.

Preferably the film is transparent.

A variety of substrates may be coated in accordance with the present invention, for example polyolefins e.g. polypropylene such as oriented polypropylene or polyesters e.g. polyethylene terephthalate. The substrate may be an oriented material e.g. biaxially oriented polyethylene terephthalate.

The invention is particularly applicable to cellulosic substrates e.g. cellulose films such as those available under the internal trade name E167, available from Innovia Films Limited. Such substrates are absorbent and hydrophilic and difficult to coat by aqueous coating methods.

As noted above, the coating is applied by means of a hot melt or extrusion coating process.

Preferably in the hot melt coating process the coating is extruded through a curtain die onto the substrate. “Curtain die” in the context of this specification includes any shape, configuration and/or number of die slots or holes which give rise to a substantially continuous falling curtain of material exiting the die. For example the die may comprise one or more co-linear (in the case of there being more than one) elongate slots and/or a co-linear series of holes.

The film substrate may be drawn during the coating step. This may be of low draw (1 or 2 times), by up to at least about 10 times, at least about 20 times, at least about 50 times, or even as high as 100 or 200 times, its original dimension in the direction of draw.

The coated films may be transparent, but can include pigmented, coloured or metallised films. Where transparent the film has wide angle haze of less than about 10%, more preferably less than about 8%, most preferably less than about 6%.

Also provided in accordance with the invention is a useful article sealed inside a package at least partly comprising the coated film of the invention.

The products of the invention may comprise suitable functional or aesthetic additives, selected for example from one or more of nitrocellulose, paraffin waxes, silicas, china clays, polyesters, candelillia wax, montan wax, microcrystalline wax, hydrogenated castor oil, behenic acid, oxidised polyethylene wax, stearic acid, glycerine mono stearate, carnauba wax, maleic acid, ethyl cellulose, styrene maleic anhydride, polyvinyl acetates, zinc stearate, dicyclohexylphthalate, acetyl tributyl citrate, polyvinyl chloride/polyvinyl acetate copolymers, amide waxes, glycerol ester of rosin and dymerex polymerised rosin.

A preferred aspect of the present invention concerns the adhesion of the PVdC to some substrates. The prior art discloses various primer layers between the substrate and the extrusion coating, to promote adhesion. In contrast, in the present invention, one or more adhesion promoter can advantageously be included in the PVdC melt before extrusion. Therefore there is no need to use a separate primer layer. The thinness of the extrusion coating in the present invention means that it is economically feasible to have such additives in the melt. Conventionally this would have been too expensive to contemplate due to the thickness of conventional PVdC coatings.

The skilled person is aware of adhesion promoters which are suitable for use in primer layers (this depends on the substrate) and the same or similar adhesion promoters can often be used in the blend. The adhesion promoters are selected from those which do not adversely react with the PVdC or additives.

For example: for cellulosic substrates, preferred adhesion promoters include epoxides, polyesters, acrylates and polyurethanes; for polypropylene substrates, preferred adhesion promoters include polyesters and acrylates.

Preferably the adhesion promoter is a migratory additive which will migrate to the surface of the coating thereby promoting adhesion between PVdC and the substrate and leaving the inner part of the layer with a lower amount of, and preferably relatively free from, the additive.

Some examples of effective adhesion promoters with respect to cellulosic substrates include isocyanates and polyesters.

From further aspects the present invention provides packaging comprising the coated substrate, and articles packaged with the coated substrate.

The invention will now be more particularly described with reference to the following non-limiting Examples and Figures in which:

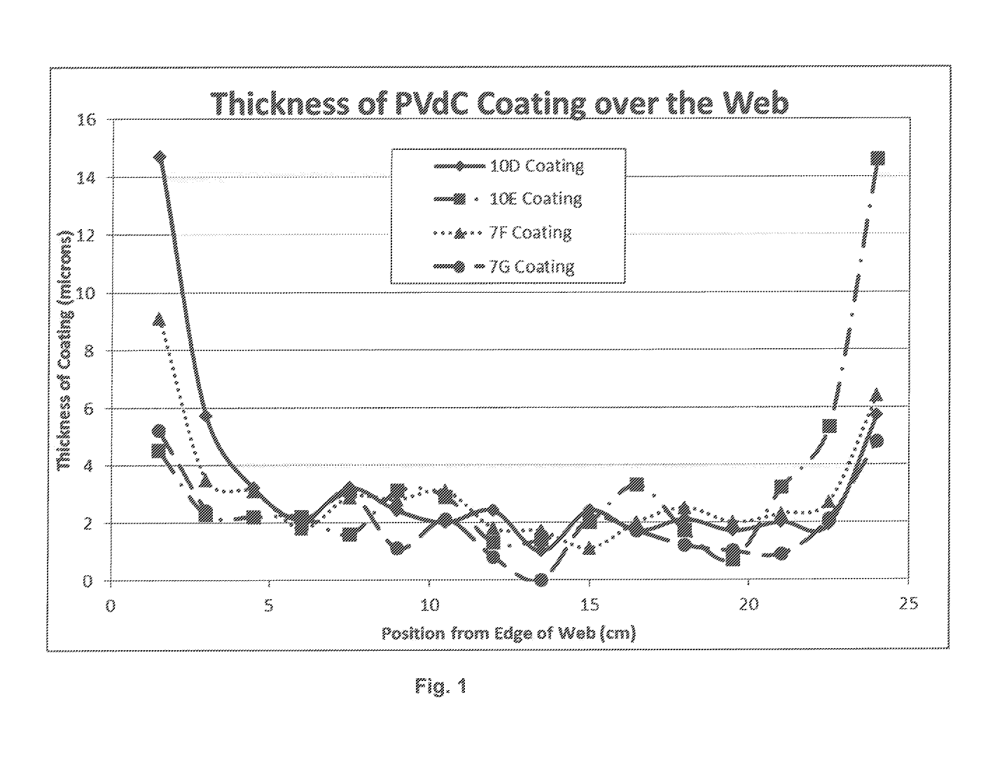

FIG. 1 shows the thickness profiles of some PVdC layers achieved by extrusion coating;

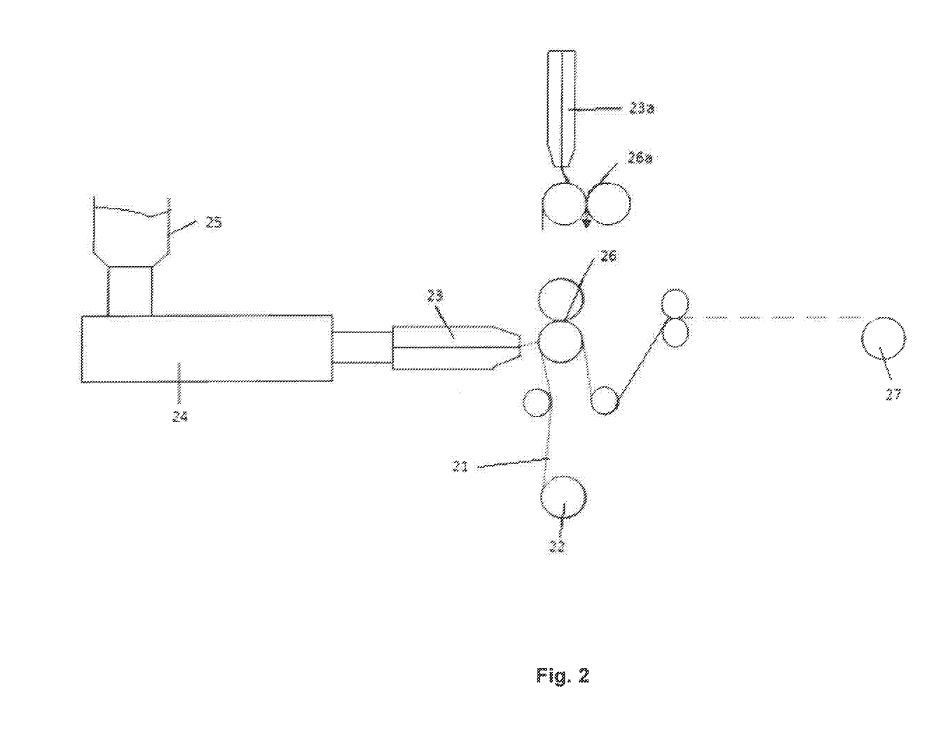

FIG. 2 shows a schematic diagram of the small scale apparatus used to make the film of the present invention;

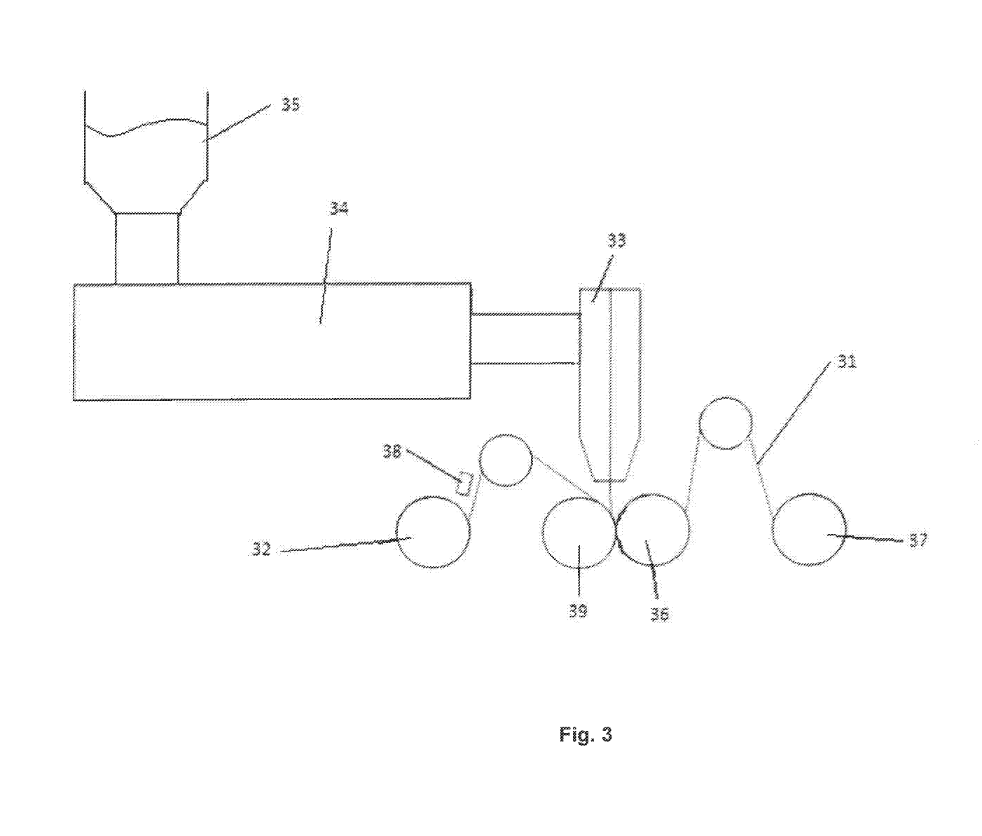

FIG. 3 shows a schematic diagram of the large scale apparatus used to make the film of the present invention; and

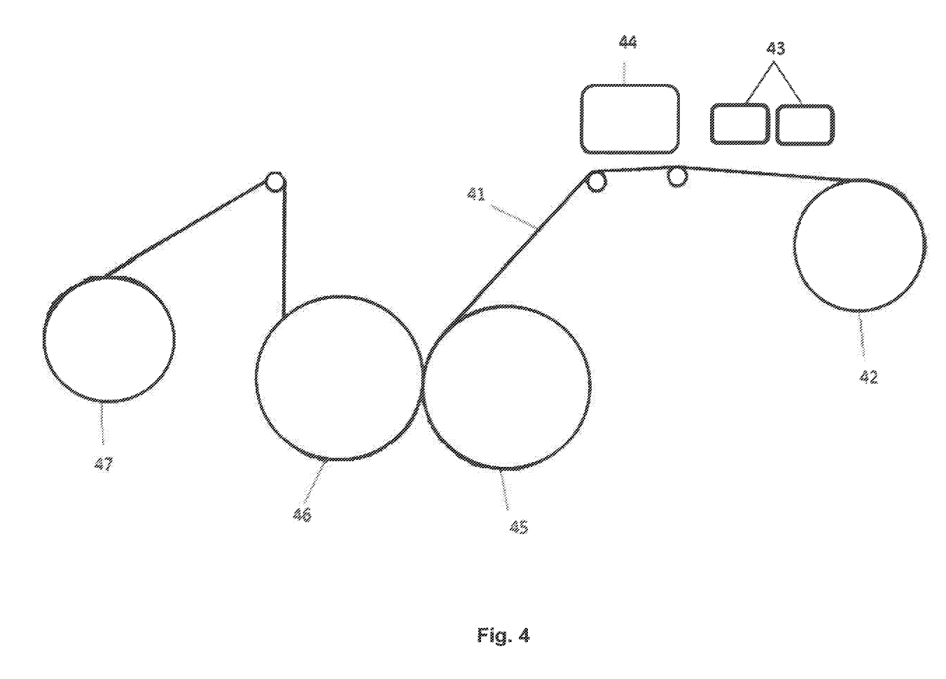

FIG. 4 shows a schematic diagram of a post-coated adhesion promoter system.

### EXAMPLES

The following chemicals were used.

PVdC's

“Type 1 standard” is a block copolymer of vinylidene chloride and vinyl chloride of relative viscosity 1.56 such as “Ixan PV708” obtainable from Solvin.

“Type 1 low” is a similar product but of lower viscosity (relative viscosity 1.38)

“Type 2 standard” is a copolymer of vinylidene chloride.

“Type 2 low” is a similar product but of lower viscosity (relative viscosity 1.38-1.4)

Adhesion Promoters

| Adhesion Promoters | | Example | | |
|---|---|---|---|---|
| Type | Chemistry | Supplier | Brand | Type |
| 1 | Polyester | Cytec | Crylcoat | Polyester |
| | | Industries | 16660-0 | |
| 2 | Urethane/ | Bayer | Crelan | Urethane/ |
| | Isocyanate | | EF403 | Isocyanate |
| 3 | Epoxide | Momentive | EPON 1007 | Epoxide |
| 4 | Copolyamide | Evonik | Vestamelt | Copolyamide |
| | Based | Industries | 750 | |
| 5 | Ethyl Acrylic | Dow | Amplify | Ethylene Ethyl |
| | Based | Chemical | 100 | Acrylate copolymer |
| | | Company | | |
| 6 | Acrylic Based | Arkema | Lotryl | Ethylene Methyl |
| | | | 28MA07 | Acrylate copolymer |
| 7 | Acrylic Acid | Dow | PRIMACOR | Ethylene Acrylic |
| | Based | Chemical | 5980I | Acid copolymer |
| | | Company | | |

Filmic Substrates

Substrate 1 is a cast cellulosic film available from Innovia Films Limited under the internal designation E167 or cellophane E167.

Substrate 2 is a cast cellulosic film available from Innovia Films Limited under the internal designation POO2 or cellophane POO2.

Substrate 3 is a cast cellulosic film available from Innovia Films Limited under the internal designation NPU or cellophane NPU.

### Example 1

FIG. 1 shows coating thicknesses obtained when using four low viscosity coating samples:
Samples 7F and 7G each comprise 50% Type 2 low and 50% Type 1 low PVdC's on substrate 1. Samples 7F and 7G differ in the speed of take off.
Samples 10E and 10D each comprise Type 2 Low PVdC with 10% Adhesion 1 on substrate 1. Samples 10E and 10D differ in the speed of take off.

It can be seen from FIG. 1 that thin PVdC coatings (around 2 micrometres) can be achieved with these particular low viscosity blends. The coatings are stable and uniform. As is normal with melt extrusion systems, the greatest thickness is seen at the edges, due to the drawing of the material during extrusion resulting in “necking”.

The following table shows thickness trials and indicates that, contrary to expectations, it is possible to optimize conditions and achieve a thin effective extrusion coating. The relative viscosity is the ratio of the viscosity of the 1% solution (measured at 1% solids in THF at 20 degrees C.) to the viscosity of the solvent.

| | Extruder Speed (rpm) | | | | | | | | |
|---|---|---|---|---|---|---|---|---|---|
| | 25 | | | | | 20 | 15 | 13 | |
| | Winder Speed (m/min) | | | | | | | | |
| | 1 | 5 | 10 | 15 | 20 | 20 | 20 | 20 | |
| | Approx. Average Coating | | | | | | | | Relative |
| | Thickness 6-18 cm (microns) | | | | | | | | Vis- |
| Sample | 35-80 | 10-20 | 3-10 | 3-6 | 2-5 | 2-4 | 1-2 | | cosity |
| Type 1 Std | Y | Y | ? | N | | | | | 1.52 |
| Type 2 Low | Y | Y | Y | ? | N | | | | 1.39 |
| Type 2 Std | Y | Y | Y | ? | N | | | | 1.44 |
| 50% Type 1 | Y | Y | Y | Y | Y | Y | Y | N | 1.39 |
| Low + | | | | | | | | | |
| 50% Type 2 | | | | | | | | | |
| Low | | | | | | | | | |

Key
Y Runs well
N Failure at melt curtain
? Stability of curtain was poor

By “Approx. Average Coating Thickness 6-18 cm” is meant that thickness measurements were taken between 6 and 18 cm across the web width and averaged.

The following table shows the effect of varying the type/blend of polymer. Standard barrel extrusion temperatures for zones 1 to 5 on the extruder were 160, 160, 160, 155, 150 degrees C. The temperature was elevated for sample using 50% Type 1 & 2 std PVdC materials: 170, 170, 170, 165, 150 degrees C. The extruder die gap was set at approximately 50 microns. The barrel temperature increases towards the die.

| | Extruder Speed (rpm) | | | | | | | | | |
|---|---|---|---|---|---|---|---|---|---|---|
| | 25 | | | | 20 | 15 | | | | |
| | | | | | | | | | Relative | |
| | Winder speed (m/min) | | | | | | | | Vis- | |
| PVdC Type | 5 | 10 | 15 | 20 | 20 | 20 | 25 | 30 | cosity | Comments |
| Type 2 Low | Y | Y− | Y−− | Y* | Y* | | | | 1.39 | |
| 85% Type 2 low + | Y | Y | Y | Y | Y* | Y− | Y* | Y* | 1.39 | |
| 15% Type 1 low | | | | | | | | | | |
| 50% Type 2 low + | Y | Y | Y | Y* | Y* | Y* | | | 1.39 | |
| 50% Type 1 low | | | | | | | | | | |
| 15% Type 2 low + | Y | Y | Y− | Y−− | | | | | 1.39 | |
| 85% Type 1 low | | | | | | | | | | |
| 50% Type 2 std + | Y | Y | Y | Y− | Y− | Y* | Y* | | 1.41 | |
| 50% Type 1 low | | | | | | | | | | |
| 50% Type 2 std + | N | | | | | | | | 1.47 | Std Conditions - |
| 50% Type 1 std | | | | | | | | | | TOO COLD |
| | | | | | | | | | | Increasing temp |
| | | | | | | | | | | sample degrades |

Key
*Edge Waver
−occasional break
−−Increased number of breaks

Without wishing to be bound by theory, combinations of type 1 and type 2 PVdC show enhanced processability when blended and we believe that the combination of low viscosity of type 1 and good melt curtain strength of type 2 provides the desired thin extrusion layer with stable melt curtain processability.

The effects of adding “Adhesion Promoter 1” were investigated and the results are shown in the following table.

| | Coating | Heat Seal Strength | |
|---|---|---|---|
| | Thickness | After 5 | After 7 |
| PVdC Formulation | (microns) | mins | Days |
| Type 2 low | 2.4 | 11 | 5 |
| 50% Type 2 low + 50% Type 1 low | 2.9 | 11 | 5 |
| 50% Type 2 low + 50% Type 1 low | 1.8 | 19 | 6 |
| 50% Type 2 low + 50% Type 1 low | 1.3 | 23 | 4 |
| Type 2 Low + 10% Adhesion 1 | 2.2 | 293 | 253 |
| Type 2 Low + 10% Adhesion 1 | 1.4 | 215 | 269 |
| 45% Type 1 low + 45% Type 2 Low + | 2.1 | 290 | 221 |
| 10% Adhesion 1 | | | |
| 45% Type 1 low + 45% Type 2 Low + | 2.1 | 222 | 260 |
| 10% Adhesion 1 | | | |

Heat sealed samples were prepared by heat sealing 25 mm sample strips at 135° C., 15 PSI for 2 sec and were pulled after the relevant time using a RDM Seal Tester at 300 mm/min pull speed.

It can be seen that, when the adhesion promoter was used, it was still possible to obtain thin coatings, and additionally effective heat seal strength was imparted.

Further experiments showing the effect of adhesion promoters on processability of blends are summarised in the following table:

| | | Winder Speed m/min (extruder Speed) | | | | | | |
|---|---|---|---|---|---|---|---|---|
| Adhesion Promoter | | 5 | 20 | 20 | 25 | 30 | 32 | |
| Type | % | (25 rpm) | (25 rpm) | (15 rpm) | (15 rpm) | (15 rpm) | (15 rpm) | Comments |
| None | 0 | Y | Y− | N* | Y @RWT | | | |
| | | | | Y− @RWT | | | | |
| 1 | 1 | Y | Y | N | Y @RWT | | | |
| | | | | Y @RWT | | | | |
| 1 | 2 | Y | y−− | N | Y* @RWT | | | |
| | | | | Y @RWT | | | | |
| 1 | 5 | Y | Y−− | Y− | | | | |
| 1 | 10 | Y | Y | Y\hat{ } | | | | |
| 2 | 1 | Y | Y− | Y\hat{ } | | | | |
| 2 | 2 | Y | Y | Y− | Y @RWT | Y\hat{ } @RWT | | |
| 2 | 5 | Y | Y | Y | | Y\hat{ } | | |
| 2 | 10 | Y | Y | Y | | Y | Yx | Stable at machine limit |
| 3 | 1 | Y | Y− | Y | | | | |
| 3 | 2 | Y | Y | Y | | Y*− | | |
| 3 | 5 | Y | Y | Y− | | ? | | |
| 3 | 10 | Y | Y− | Y\hat{ } | | | | |
| 1 + 2 | 5 + 5 | Y | Y | Y | | Y*− | | |
| 1 + 2 | 10 + 10 | Y | Y | | | | | Only Tested to 20 |
| | | | | | | | | (25 rpm) |

Key
−occasional breaks
\hat{ }Wrap Up
*edge waver
xminor edge waver
−−Increased number of breaks
RWTReduced Winding Tension

### Example 2

### Small Scale Trials

Schematic of Laboratory Set Up for Lab Scale Production

FIG. 2 shows a schematic view of the apparatus used in the small scale trials. A polymer web 21 is unwound from a reel 22 and is passed next to a die 23 at a distance d. Behind the die 23 is an extruder barrel 24 into which a PVdC blend is fed from container 25. The die 23 feeds the PVdC blend onto the polymer web 21 which runs over a heated steel roller 26 (temperature as described in experimental data). The coated web 21 then cools and is wound onto reel 27.

FIG. 2 also shows an alternative position for the die 23a and the heated steel roller 26a. The functioning of the arrangement is otherwise the same as that described above.

In all of the experiments in Example 2, the extruder/die and nip rollers were set up as shown in FIG. 2 and were run under a series of standard conditions. Melting the PVdC blends was achieved by heating the PVdC in the extruder under different shears to temperatures of between 140 and 175° C. (depending upon formulation) at the die exit. Work was carried out at a range of rates and shears (see rpm for speed of extruder in the results below). The aim of the work was to produce low thickness coatings on a polymer web, which was successfully achieved through both a 20 and 30 cm die, with approximately 1 cm distance between the die and nip/casting roller, unless otherwise mentioned in the experiment.

If the film was heated in the test, this was achieved by passing the film over pre-heated nip rollers (26 or 26a) before being coated and nipped. The temperature of the film was controlled by the roller temperatures which were usually held between 30 and 90° C. Unless mentioned in the experimental procedure, the temperature of the roller can be assumed to be 30° C. Unless otherwise noted, analysis of samples can be assumed to be for the complete construction (i.e. film/films+coating layer).

Improved adhesion between layers should be possible by post heat treating the samples and/or increasing the initial pressure and/or nip force. Post coating and/or hot pressing does improve the adhesion of the materials, as can be seen in the results shown previously and proof of post heat treatment can be seen in Example 5. Adhesion of the PVdC to a substrate film is carried out using a standard adhesion tape test, where % adhesion is quoted, or by attempted separation of the films on a heat seal tester under standard running conditions where forces are quoted.

The standard adhesion tape test consists of applying a minimum of 5 cm of red Scapa tape (grade 1112) smoothing it on the surface of the PVdC coating, waiting a few seconds for it to settle and then pulling the tape off at a rate of greater than 20 m/min. Results of % loss are determined optically from multiple tests and an average taken for the samples. An adhesion of 0% during the tape test does not mean that the film was not stuck to the substrate film, but instead means that the adhesion of the PVdC layer is greater to the test tape than to the film it is being tested against. Thus, any PVdC sample with an adhesion of 0% to the tape test means that the coating layer can be removed relatively easily from the film.

Distance from Die to Roller Effects Using the Preferred Adhesion Promoters

The preferred blend of PVdCs (85% Type 2 low 15% Type 1 low) and blended adhesion promoters (10% Type 1 and 10% Type 2) were run through the extruder using standard conditions before being cast onto a cellulose base film (substrate 3) and sandwiched with a different cellulose base film (substrate 1). The extruder was run at 40 rpm with the die at variable distances from the rollers (1-30 cm) of the winder. The film was wound through twin heated rollers (both being at the same temperature) where the film and PVdC coating were nipped together at various speeds. This allowed the production of a laminated film with various thicknesses. As expected, varying the winding speed affected the thickness of the coating material as well as the degree of necking of the sample. The distance from the die to the rollers was adjusted and the sample films collected. These sample films were then tested for their optical properties (gloss, haze) and adhesion to the substrate using the standard tape test mentioned above. As can be seen in the table below, the materials generally show reasonable adherence to substrate 1.

| Distance to Die | | | NAH | | Haze Guard | | % Adhesion | Film PVdC |
|---|---|---|---|---|---|---|---|---|
| (cm) | Gloss 45° | WAH % | Min | Max | Haze | Clarity | after tape test | Adhered to |

Adhesion Promoter 10% Type 1 + 10% Type 2 Extruder Output 40 rpm Rollers 80° C. 20 m/min

| | | | | | | | | |
|---|---|---|---|---|---|---|---|---|
| 1 | 66.1 | 11.3 | 18.1 | 24.7 | 11.2 | 80.7 | 50 | E167 |
| 5 | 67.3 | 11.6 | 15.6 | 21.0 | 10.7 | 82.6 | 50 | E167 |
| 10 | 74.3 | 10.4 | 17.2 | 21.2 | 10.3 | 83.3 | 50 | E167 |
| 30 | 77.1 | 11.0 | 17.1 | 21.2 | 10.3 | 86.3 | 50 | E167 |

Rollers 90° C. 10 m/min

| | | | | | | | | |
|---|---|---|---|---|---|---|---|---|
| 10 | 62.3 | 10.3 | 19.2 | 26.2 | 10.5 | 81.3 | 40 | E167 |
| 30 | 46.2 | 9.0 | 15.9 | 26.9 | 9.4 | 82.5 | 40 | E167 |

Pre-Heating/Casting Roller Temperature Effects Upon Adhesion Using the Preferred Test PVdC Coating Containing Adhesion Promoters 1 & 2

The preferred blend of PVdCs (85% Type 2 low 15% Type 1 low) and blended adhesion promoters (10% Type 1 and 10% Type 2) was run through the extruder using standard conditions before being cast onto a cellulose base film (substrate 3) and sandwiched with a different cellulose base film (substrate 1). The extruder was run at 35 rpm with the die 30 cm away from the winder. The film was wound through twin heated rollers where the film and coating were nipped together at 5 m/min, thus giving a significantly thicker material than normally produced and outside the range of the present invention. The material rollers were adjusted to give a range of temperatures and the sample films collected. These sample films were then tested for their optical properties (gloss, haze) and adhesion to the substrate. As can be seen in the table below, the materials generally did not adhere to either of the substrates until an initial temperature was reached. After this temperature, the PVdC coating preferentially adhered to only the substrate 1.

| Roller | | | NAH | | Haze Guard | | % Adhesion | Film PVdC |
|---|---|---|---|---|---|---|---|---|
| Temperature | Gloss 45° | WAH % | Min | Max | Haze | Clarity | after tape test | Adhered to |

Adhesion Promoter 10% Type 1 + 10% Type 2 Extruder Output 40 rpm Die Distance 30 cm 5 m/min

| | | | | | | | | |
|---|---|---|---|---|---|---|---|---|
| 35° C. | 53.9 | 12.3 | 15.0 | 25.9 | 10.6 | 84.0 | 0 | none |
| 40° C. | 68.4 | 14.2 | 13.2 | 27.0 | 10.6 | 84.6 | 0 | none |
| 45° C. | 37.5 | 14.8 | 19.5 | 25.5 | 14.7 | 79.0 | 0 | none |
| 50° C. | 53.6 | 13.1 | 14.4 | 21.7 | 14.0 | 78.7 | 0 | none |
| 55° C. | 58.1 | 16.5 | 16.5 | 23.3 | 13.5 | 80.4 | 0 | none |
| 60° C. | 62.0 | 12.3 | 17.3 | 26.0 | 12.8 | 80.3 | 0 | none |
| 65° C. | 69.5 | 12.2 | 17.6 | 22.1 | 11.2 | 83.0 | 0 | none |
| 70° C. | 56.4 | 13.3 | 14.0 | 24.0 | 11.2 | 79.9 | 50 | Substrate 1 |
| 75° C. | 56.0 | 14.9 | 16.8 | 25.0 | 12.8 | 80.3 | 50 | Substrate 1 |
| 90° C. | 44.4 | 14.5 | 14.4 | 24.9 | 13.7 | 84.8 | 60 | Substrate 1 |

For the materials used in the above experiment, the data above demonstrates that the roller temperature must be above 65° C. for effective adhesion to occur. However, it is to be understood that alternative materials may require different temperatures.

### Example 3

### Large Scale Trials

Schematic of Equipment Used for Large Scale Sample Production

FIG. 3 shows a schematic view of the apparatus used in the large scale trials. A polymer web 31 is unwound from a reel 32 and is passed underneath a heating element 38. The polymer web 31 is then passed between a rubber roller 39 and a steel roller 36, while PVdC is simultaneously applied from die 33. Behind the die 33 is an extruder barrel 34 into which a PVdC blend is fed from container 35. The die 33 feeds the PVdC blend onto the polymer web 31 and the coated web 31. The coated web 31 cools and is then wound onto reel 37.

In all of the experiments of Example 3, the extruder/die and nip rollers were set up as shown in FIG. 3 and were run under a series of standard conditions. Melting the PVdC blends was achieved by heating the PVdC in the extruder under different shears to temperatures of between 140 and 175° C. at the die exit. Work was carried out at a range of output rates and shears (see rpm for speed of extruder in the results below). The aim of the work was to produce low thickness coatings on a wide web, which was successfully achieved. The ability to scale from 20 and 30 cm on laboratory lines to a 600 mm die proves that the technology can be scaled to give thin wide web width coatings. The extruder's total output was through a 600 mm wide die with an approximately 5 cm drop to the nip roller, unless otherwise mentioned in the experimental description. If the film was “hot” in the test, this was achieved by pre-heating the film's surface using a series of IR heaters, which heated the film to temperatures of about 50-70° C. (the temperature being taken from the film surface using an IR gun), before being coated. Cold film was the result of running the machine without pre-heating the film and was carried out at room temperature.

Effect of Adhesion Promoter/Film Type (Substrate 1)

Substrate 1 base films were coated with a range of PVdC materials with different MFIs and containing different adhesion promoters. These sample films were then tested for their optical properties (gloss, haze), thickness and adhesion of the PVdC blend to the filmic substrate. As can be seen in the table below, the materials show various levels of adhesion to the base substrates, which depends upon both the adhesion promoter used and the run conditions. In all cases, the coatings on the filmic substrates are within the thickness range of the present invention and most show good optical results.

Substrate 1

The table below shows results for adhesion of the preferred blend of PVdCs (85% Type 2 low 15% Type 1 low) and an alternate low viscosity blend PVdC B (50% Type 2 low 50% Type 1 low), on their own and blended with different adhesion promoters to the substrate film, when it was both cold and when heated. The results below show that the thicknesses of the coating layers are within the range of the present invention. As can be seen from running these samples at a coating distance of about 5 cm between the die and nip point using the stated conditions, adhesion is only seen in the presence of promoter type 1, although it appears that the presence of a type 2 adhesion promoter improves the efficiency of type 1 with respect to adhesion and improves the stability of the melt curtain. This allows samples to be run with a lower output and thus gives a thinner coating. The adhesion improves with pre-heating of the base film, as expected.

| | | Speed | | | | | | | | | | Thickness | | |
|---|---|---|---|---|---|---|---|---|---|---|---|---|---|---|
| Adhesion | Film | Extruder | Winder | | | NAH | | | Colour transmission | | | (microns) | | % Residue |
| Promoter | State | (rpm) | (m/min) | Gloss | WAH | Min | Max | Opacity | L | a | b | Average | ^{~}coat | after Tape Test |
| none | cold | 20 | 70 | 52.2 | 24.9 | 28.7 | 34.0 | 12 | 94.484 | −0.009 | 0.33 | 30.6 | 2.8 | 0 |
| none | cold | 20 | 90 | 46.7 | 32.9 | 23.0 | 30.3 | 14 | 93.875 | 0.025 | −0.073 | 30.3 | 2.5 | 0 |
| none | cold | 20 | 110 | 43.4 | 40.6 | 20.0 | 27.3 | 15 | 92.913 | 0.017 | −0.068 | 29.9 | 2.1 | 0 |
| 10% Type 1 + | cold | 50 | 70 | 86.2 | 9.2 | 21.2 | 30.1 | 10 | 95.821 | −0.037 | 0.503 | 31.9 | 4.1 | 20 |
| 10% type 2 | | | | | | | | | | | | | | |
| 10% Type 1 + | cold | 50 | 90 | 65.1 | 9.1 | 20.7 | 28.2 | 9 | 95.724 | −0.038 | 0.459 | 30.3 | 2.5 | 10 |
| 10% type 2 | | | | | | | | | | | | | | |
| 10% Type 1 + | cold | 50 | 110 | 84.6 | 10.7 | 15.7 | 20.6 | 9 | 95.522 | −0.032 | 0.504 | 30.4 | 2.6 | 20 |
| 10% type 2 | | | | | | | | | | | | | | |
| 10% Type 1 + | hot | 30 | 110 | 54.0 | 20.4 | 14.2 | 21.2 | 9 | 95.564 | −0.009 | 0.462 | 29.6 | 1.8 | 20 |
| 10% type 2 | | | | | | | | | | | | | | |
| 10% Type 1 | cold | 20 | 90 | 53.3 | 15.6 | 22.8 | 26.0 | 10 | 95.239 | −0.025 | 0.519 | 30.4 | 2.6 | 0 |
| 10% Type 1 | hot | 20 | 70 | 58.4 | 11.7 | 20.8 | 24.0 | 10 | 93.362 | 0.009 | 0.581 | 31.0 | 3.2 | 0 |
| 10% Type 1 | hot | 20 | 90 | 51.9 | 17.7 | 20.6 | 25.8 | 11 | 95.391 | −0.026 | 0.489 | 30.3 | 2.5 | 0 |
| 10% Type 1 | hot | 20 | 110 | 71.6 | 18.5 | 20.8 | 25.7 | 10 | 95.024 | −0.02 | 0.54 | 29.9 | 2.1 | 0 |
| 10% Type 2 | cold | 20 | 90 | 69.8 | 12.6 | 18.1 | 26.1 | 11 | 95.442 | −0.032 | 0.554 | 29.5 | 1.7 | 0 |
| 10% Type 2 | hot | 20 | 90 | 52.9 | 13.7 | 12.1 | 19.2 | 11 | 94.93 | −0.02 | 0.544 | 30.2 | 2.4 | 0 |
| 10% Type 2 | hot | 20 | 110 | 39.2 | 19.9 | 17.1 | 23.0 | 10 | 95.225 | −0.029 | 0.59 | 30.0 | 2.2 | 0 |
| 10% Type 1 + | cold | 50 | 70 | 69.4 | 16.7 | 25.1 | 32.0 | 10 | 95.164 | −0.02 | 0.553 | 29.4 | 1.6 | 0 |
| 10% Type 4 | | | | | | | | | | | | | | |
| 10% Type 1 + | hot | 50 | 70 | 65.7 | 13.9 | 18.4 | 22.1 | 10 | 95.447 | −0.022 | 0.567 | 30.1 | 2.3 | 2 |
| 10% Type 4 | | | | | | | | | | | | | | |
| 10% Type 1 + | cold | 50 | 90 | 88.4 | 9.6 | 17.2 | 21.1 | 11 | 95.001 | −0.019 | 0.581 | 30.3 | 2.5 | 5 |
| 10% Type 4 | | | | | | | | | | | | | | |
| 10% Type 1 + | hot | 50 | 90 | 73.2 | 13.3 | 15.1 | 24.0 | 10 | 95.44 | −0.023 | 0.573 | 30.0 | 2.2 | 10 |
| 10% Type 4 | | | | | | | | | | | | | | |
| PVdC B None | cold | 20 | 90 | 76.1 | 28.7 | 17.6 | 25.5 | 11 | 94.746 | 0.009 | 0.204 | 29.2 | 1.4 | 10 |
| PVdC B None | cold | 20 | 90 | 51.5 | 29.4 | 18.0 | 21.1 | 14 | 94.234 | 0.029 | 0.173 | 30.2 | 2.4 | 0 |

Substrate 2

As shown by the results below, the preferred blend of PVdCs (85% Type 2 low 15% Type 1 low) and blended adhesion promoters (10% Type 1 and 10% Type 2) showed adhesion to the substrate both cold and when heated. The thicknesses of the coatings are within the range of the present invention. The adhesion improves with pre-heating of the base film as expected. Comparison between these large scale results and those on the laboratory scale highlights the difference in film preparation on the adhesion of the materials. For example, direct heating onto the surface to be coated using the IR heaters in this test is significantly better than heating through the film in prior laboratory trials. These preheating effects are film dependent, but will probably be true for most films, especially for all moisture sensitive films. This level and form of heating of the film is not the equivalent of corona treatment of the film, although corona discharge treatment of the film may help with adhesion of the tie layer.

| | Speed | | | | | | | | | | | | |
|---|---|---|---|---|---|---|---|---|---|---|---|---|---|
| Film | Extruder | Winder | | | NAH | | | Colour transmission | | | Thickness (microns) | | % Residue |
| State | (rpm) | (m/min) | Gloss | WAH | Min | Max | Opacity | L | a | b | Average | ^{~}coat | after Tape Test |

Adhesion Promoters used 10% Type 1 + 10% type 2 Substrate Cellophane POO2

| | | | | | | | | | | | | | |
|---|---|---|---|---|---|---|---|---|---|---|---|---|---|
| cold | 20 | 70 | 75.1 | 14.5 | 29.4 | 33.2 | 10 | 95.428 | −0.042 | 0.469 | 22.4 | 2.7 | 20 |
| cold | 20 | 90 | 60.1 | 16.6 | 26.2 | 31.1 | 10 | 95.189 | −0.051 | 0.526 | 22.0 | 2.3 | 10 |
| cold | 15 | 110 | 41.7 | 24.0 | 15.2 | 20.2 | 10 | 95.362 | −0.032 | 0.425 | 21.3 | 1.6 | 20 |
| hot | 20 | 70 | 80.4 | 11.4 | 21.1 | 26.3 | 10 | 95.089 | −0.041 | 0.528 | 22.4 | 2.7 | 50 |
| hot | 20 | 90 | 59.2 | 15.7 | 19.1 | 26.8 | 10 | 95.151 | −0.038 | 0.484 | 22.4 | 2.7 | 50 |
| hot | 20 | 110 | 75.4 | 14.4 | 23.0 | 29.2 | 10 | 95.022 | −0.019 | 0.492 | 21.9 | 2.2 | 50 |
| hot | 15 | 110 | 46.2 | 22.7 | 29.1 | 33.0 | 10 | 95.047 | −0.041 | 0.577 | 21.9 | 2.2 | 80 |

Processing Conditions Distance from Die to Roller Effects Using Adhesion

Promoters 1 & 2

The preferred blend of PVdCs (85% Type 2 low 15% Type 1 low) and blended adhesion promoters (10% Type 1 and 10% Type 2) was run through the extruder using standard conditions before being cast onto substrate 1. The extruder was run at a range of speeds with the die at variable distances from the nip rollers (1-10 cm). The film was preheated before coating using a series of IR heaters to generate a pre-warmed film before being coated. The distance from the die to the rollers was adjusted and the sample films collected. These sample films were then tested for their optical properties (gloss, haze), thickness and adhesion to the substrate. As can be seen in the table below, the materials generally show reasonable adherence to substrate 1 and thicknesses generally within the range of the present invention.

| Film State/ | Speed | | | | | | | | | | | | |
|---|---|---|---|---|---|---|---|---|---|---|---|---|---|
| Distance to Die | Extruder | Winder | | | NAH | | | Colour transmission | | | Thickness (microns) | | % Residue |
| (cm) | (rpm) | (m/min) | Gloss | WAH | min | Max | Opacity | L | a | b | Average | ^{~}coat | after Tape Test |

Adhesion Promoters used 10% Type 1 + 10% type 2 Substrate Cellophane E167

| | | | | | | | | | | | | | |
|---|---|---|---|---|---|---|---|---|---|---|---|---|---|
| hot/5 | 100 | 100 | 73.0 | 9.8 | 14.8 | 20.5 | 11 | 95.281 | −0.073 | 0.549 | 33.7 | 5.9 | 50 |
| hot/10 | 100 | 100 | 87.0 | 7.2 | 4.0 | 20.6 | 10 | 95.399 | −0.072 | 0.53 | 35.1 | 7.3 | 60 |
| hot/1 | 100 | 100 | 78.2 | 8.3 | 17.4 | 23.3 | 11 | 95.699 | −0.115 | 0.468 | 35.9 | 8.1 | 60 |
| hot/1 | 25 | 70 | 73.7 | 10.8 | 6.3 | 13.5 | 9 | 95.836 | −0.044 | 0.48 | 30.1 | 2.3 | 60 |
| hot/1 | 50 | 70 | 83.8 | 8.7 | 3.8 | 20.2 | 9 | 95.769 | −0.102 | 0.567 | 32.5 | 4.7 | 10 |
| hot/1 | 75 | 70 | 77.6 | 8.6 | 13.1 | 16.5 | 10 | 95.795 | −0.076 | 0.53 | 30.8 | 3.0 | 40 |
| hot/1 | 20 | 70 | 55.6 | 18.8 | 26.4 | 33.8 | 9 | 95.585 | −0.098 | 0.533 | 30.0 | 2.2 | 20 |

Effect of Adhesion and Film Type

As proof of applicability of the technique to other films types, additional films types with properties significantly different from substrate 1 were selected, specifically PET (36 μm PET film available from MetLux reference: 1AAN040417VD0036) and BOPP (standard surface activated BOPP film available from Innovia Films Limited). Samples of PVdC were extruded onto these films under standard conditions. The PVdC contained no adhesion promoter, blended adhesion promoters 1 & 2 or adhesion promoters 4 & 5. These coated sample films were then tested for their optical properties (gloss, haze), thickness and adhesion to the substrate. As can be seen in the table below, the materials show various levels of adhesion to the base substrates. These results prove that the production of thin PVdC coated films can be made using our approach and the selected adhesion promoter is determined by both the materials being bonded together and the processing conditions used. As can also be seen below, preheating a film often improves adhesion of the PVdC to the material (as previously seen with the substrate 1).

| | | | | | | | | | | | | | | | % |
|---|---|---|---|---|---|---|---|---|---|---|---|---|---|---|---|
| | | | Speed | | | | | | | | | | | Coat | Residual |
| | | | Ex- | | | | | | | Colour | | | Thick- | Thick- | Coating |
| Film | Adhesion | Film | truder | Winder | | | NAH | | Opac- | Transmission | | | ness | ness | (Adhe- |
| Type | Promoter | State | (rpm) | (m/min) | Gloss | WAH | Min | Max | ity | L | a | b | (microns) | (microns | sion) |
| BOPP | 10% Type 1 + | cold | 50 | 70 | 80.9 | 14.7 | 13.0 | 22.0 | 9 | 95.363 | 0.01 | 0.341 | 51.0 | 3.0 | 100 |
| | 10% Type 2 | | | | | | | | | | | | | | |
| BOPP | 10% Type 1 + | hot | 50 | 70 | 83.2 | 7.3 | 14.0 | 24.5 | 9 | 96.118 | −0.009 | 0.393 | 51.4 | 3.4 | 100 |
| | 10% Type 2 | | | | | | | | | | | | | | |
| BOPP | 10% Type 1 + | hot | 100 | 110 | 78.6 | 10.6 | 13.0 | 23.5 | 10 | 94.365 | 0.06 | 0.59 | 51.3 | 3.3 | 100 |
| | 10% Type 2 | | | | | | | | | | | | | | |
| BOPP | 10% Type 4 + | cold | 30 | 70 | 39.1 | 28.6 | 24.5 | 32.0 | 11 | 95.658 | 0.001 | 0.326 | 53.7 | 5.7 | 10 |
| | 10% Type 5 | | | | | | | | | | | | | | |
| PET | 10% Type 4 + | cold | 30 | 70 | 49.3 | 35.1 | 19.0 | 28.0 | 14 | 93.036 | 0.013 | 0.455 | 38.6 | 3.4 | 20 |
| | 10% Type 5 | | | | | | | | | | | | | | |
| PET | 10% Type 1 + | cold | 20 | 90 | 56.6 | 23.0 | 25.5 | 32.0 | 11 | 94.781 | −0.033 | 0.729 | 37.6 | 2.4 | 90 |
| | 10% Type 2 | | | | | | | | | | | | | | |
| PET | 10% Type 1 + | hot | 20 | 90 | 62.4 | 19.9 | 17.5 | 26.0 | 11 | 94.881 | −0.025 | 0.785 | 36.9 | 1.7 | 100 |
| | 10% Type 2 | | | | | | | | | | | | | | |
| PET | None | cold | 20 | 90 | 61 | 20.9 | 24.4 | 31.1 | 12 | 94.266 | 0.019 | 0.492 | 37.4 | 2.1 | 5 |

Effect of PVdC Viscosity and Further Adhesion Promoters

As proof of applicability of the technique, tests were carried out using other PVdC viscosities. Comparable tests were run using a medium viscosity PVdC and blends of this material with the low viscosity materials. A range of adhesion promoters were tried with these PVdC samples using substrate 1. Samples of the blended PVdCs were extruded onto the films as above. The PVdC contained either no adhesion promoter or one of a wide range of adhesion promoting materials. Our preferred PVdC blend was also added to the medium molecular weight PVdC and the materials run through the system. These results show that thicknesses below 10 μm are achievable by choice of material viscosity. Comparison of medium viscosity material, the medium viscosity blend and the low viscosity blend showed that running all three materials at 20 rpm and drawing off at 90 m/min achieved PVdC coating thicknesses of 4.2, 2.8 and 2.5 μm respectively. The addition of adhesion promoters affects the processability of the material both in terms of melt curtain stability and viscosity. Not all adhesion promoters have the same effectiveness and thus careful selection of adhesion promoter type, material viscosity and film type are important.

| | | | | | | | | | | | | Film + | | | |
|---|---|---|---|---|---|---|---|---|---|---|---|---|---|---|---|
| | | | | | | | | | | | | Coating | Coating | | |
| | | Speed | | | | | | | | | | Thick- | Thick- | | |
| | Film/ | Ex- | | | | | | | Colour | | | ness | ness | Tape Test | |
| Adhesion | Film | truder | Winder | | | NAH | | Opac- | Transmission | | | (mi- | (mi- | Res- | Failure Mode/ |
| Promoter | State | (rpm) | (m/min) | Gloss | WAH | Min | Max | ity | L | a | b | crons) | crons) | idue | observations |

100% Medium Viscosity PVdC

| None | E167/ | 20 | 70 | 111.2 | 3.9 | 8.7 | 10.1 | 12 | 94.892 | −0.010 | 0.390 | 32.6 | 4.8 | 0 | adhesive fail + |
|---|---|---|---|---|---|---|---|---|---|---|---|---|---|---|---|
| | cold | | | | | | | | | | | | | | cohesive fail |
| None | E167/ | 20 | 90 | 118.2 | 3.8 | 8.3 | 9.7 | 12 | 94.576 | −0.005 | 0.361 | 32.0 | 4.2 | 0 | adhesive fail + |
| | cold | | | | | | | | | | | | | | cohesive fail |
| 20% | E167/ | 20 | 30 | 71.4 | 12.9 | 28.0 | 33.5 | 11 | 94.768 | 0.027 | 0.918 | 37 | 9.2 | 0 | adhesive fail + |
| Type 6 | cold | | | | | | | | | | | | | | cohesive fail |
| 20% | E167/ | 20 | 40 | 59.2 | 22.8 | 28.0 | 34.0 | 10 | 94.097 | 0.091 | 1.297 | 34.3 | 6.5 | 0 | adhesive fail + |
| Type 6 | hot | | | | | | | | | | | | | | cohesive fail |
| None | POO2/ | 20 | 90 | 112.1 | 15.6 | 2.5 | 19.5 | 12 | 94.818 | −0.042 | 0.385 | 21.9 | 2.2 | 0 | adhesive fail + |
| | cold | | | | | | | | | | | | | | cohesive fail |
| 20% | E167/ | 20 | 90 | 57.4 | White/Pearlescent | | | 16 | 92.562 | −0.005 | 0.006 | 30.6 | 2.8 | 0 | adhesive fail + |
| Type 7 | cold | | | | Film | | | | | | | | | | cohesive fail |
| 20% | E167/ | 20 | 100 | 52.9 | White/Pearlescent | | | 16 | 92.685 | −0.009 | 0.163 | 31.0 | 3.2 | 0 | adhesive fail + |
| Type 7 | cold | | | | Film | | | | | | | | | | cohesive fail |
| 4% | E167/ | 20 | 70 | 45.2 | 44.2 | 17.2 | 25.0 | 14 | 93.018 | −0.016 | 0.199 | 31.3 | 3.5 | 0 | adhesive fail + |
| Type 7 | hot | | | | | | | | | | | | | | cohesive fail |
| 4% | E167/ | 20 | 90 | 53.6 | 40.4 | 13.5 | 27.5 | 15 | 92.907 | −0.002 | −0.052 | 30.5 | 2.7 | 0 | adhesive fail + |
| Type 7 | hot | | | | | | | | | | | | | | cohesive fail |

50% Medium Viscosity PVdC + 50% Preferred PVdC
Composition (85% Type 1 + 15% Type 2)

| | | | | | | | | | | | | | | | |
|---|---|---|---|---|---|---|---|---|---|---|---|---|---|---|---|
| None | E167/ | 20 | 90 | 72.7 | 13.0 | 23.3 | 32.0 | 11 | 95.021 | 0.002 | 0.441 | 30.7 | 2.9 | 0 | adhesive fail + |
| | cold | | | | | | | | | | | | | | cohesive fail |
| None | E167/ | 15 | 110 | 41.7 | 52.9 | 18.0 | 34.0 | 12 | 94.421 | 0.023 | 0.320 | 30.3 | 2.5 | 0 | adhesive fail + |
| | cold | | | | | | | | | | | | | | cohesive fail |

### Example 4

### Distance from Die to Roller Effects Using an Alternate Adhesion Promoter

An alternate blend of PVdC's (85% Type 2 low 15% Type 1 low) and 10% adhesion promoter 4 was run through the extruder on a small scale using standard conditions before being cast onto a cellulose base film (substrate 3) and sandwiched with a different cellulose base film (substrate 1). The extruder was run at 35 rpm with the 30 cm wide die at variable distances from the nip rollers (1-30 cm) of the winder. The film was wound through twin heated rollers, both of which were at the same temperature. The film and coating were nipped together at various speeds, which allowed the production of a laminated film with various thicknesses. As expected, varying the winding speed affects the thickness of the material, as does any necking of the sample.

The distance from the die to the rollers was adjusted and the sample films collected. These sample films were then tested for their optical properties (gloss, haze), thickness and adhesion to the substrate. Average coating thickness results for the samples were calculated as being between 2 and 14 cm width on all four coated samples, as the sample at 30 cm from the die had undergone necking in to give a total coating width of 18.4 cm whereas the sample at 1 cm gave a coating width of 27.8 cm. As can be seen in the table below, the materials generally showed no adherence to either base substrate. Attempts to heat seal these materials after processing also resulted in negligible adhesion to substrate 1.

The adhesion promoter is ineffective on this particular substrate but this example demonstrates the formation of thin extrusion coatings despite this. Adhesion promoters of type 4 may be effective for different substrates.

| | | | | | | | % | | Films + | Approx |
|---|---|---|---|---|---|---|---|---|---|---|
| Distance to Die | | | NAH | | Haze Guard | | Adhesion | Film PVdC | Coating | Coating |
| (cm) | Gloss 45° | WAH % | Min | Max | Haze | Clarity | after tape | Adhered to | Thickness | Thickness |

Adhesion Promoter 10% Type 4 Extruder Output 35 rpm Rollers 80° C. 20 m/min

| | | | | | | | | | | |
|---|---|---|---|---|---|---|---|---|---|---|
| 1 | 55.5 | 13.6 | 21.1 | 28.0 | 13.3 | 78.7 | 0 | Not | 65 | 5.3 |
| 5 | 58.5 | 12.0 | 19.8 | 24.0 | 12.2 | 80.4 | 0 | Not | 65 | 5.1 |
| 10 | 66.1 | 11.6 | 19.1 | 24.5 | 11.1 | 79.5 | 0 | Not | 64 | 4.2 |
| 30 | 58.7 | 13.7 | 19.6 | 24.1 | 12.9 | 79.8 | 0 | Not | 67 | 6.9 |

Barrier Properties

A range of films produced above were tested for the effect of melt extruded PVdC film on the material's barrier properties. As can be seen below, results from the samples tested using standard WVP, OTR and WVTR test methods show that the barrier properties of the materials have increased with the addition of an external layer. Further, the level of barrier varies with the adhesion promoter used and the thickness of the film.

WVP Test

A range of samples were tested under standard UK tropical WVP test conditions (38° C., 90% Relative Humidity). The samples were monitored until an average weight gain per day was achieved, which normally happened between 1 and 2 days after starting the test. As shown by the results below, the barrier properties of a film is improved by the addition of a thin coating of PVdC to the film, as expected. Materials with poor water barrier properties show greater changes in properties than those with good water barrier properties.

| | | PVdC | WVP Result |
|---|---|---|---|
| | | Film | (ave. gain |
| Polymeric Film | Adhesion Promoter/PVdC | Thickness | gsm/day) |
| PET | none | 0.0 | 17.1 |
| | 10% Type 1 & 10% Type 2 | 1.7 | 22.2 |
| PP | none | 0.0 | 6.2 |
| | 10% Type 1 & 10% Type 2 | 3.3 | 3.4 |
| Cellophane P002 | none | 0.0 | 2356.7 |
| | 10% Type 1 & 10% Type 2 | 2.2 | 541.1 |
| Cellophane E167 | none | 0.0 | 2636.4 |
| | 10% Type 1 & 10% Type 2 | 2.3 | 1800.6 |
| | PVdC no Promoter | 2.8 | 45.3 |

The effect of an adhesion promoter and loading of material are also shown and as expected, addition of the adhesion promoter to the PVdC coating does have a negative effect on the material's overall barrier properties. However, in nearly all cases the properties of the coated film is better than the uncoated film. These results highlight that the adhesion promoter, adhesion strength and coating thickness are all critical parameters when choosing the desired final formulation.

| | | | |
|---|---|---|---|
| | | PVdC | WVP Result |
| | | Film | (ave. gain |
| Polymeric Film | Adhesion Promoter/PVdC | Thickness | gsm/day) |

Preferred PVdC Blend

| | | | |
|---|---|---|---|
| Cellophane E167 | none | 0 | 2636.4 |
| Cellophane E167 | PVdC no Promoter | 2.8 | 45.3 |
| Cellophane E167 | 10% Type 1 | 2.1 | 309.8 |
| Cellophane E167 | 10% Type 1 & 10% Type 2 | 2.3 | 1800.6 |
| Cellophane E167 | 10% Type 2 | 2.4 | 254.0 |

PVdC Med Viscosity

| | | | |
|---|---|---|---|
| Cellophane E167 | 4% Type 7 | 3.5 | 13.4 |

OTR & WVTR Results

A range of samples were produced on a large scale using the preferred PVdC blend (85% Type 2 low 15% Type 1 low) and a range of adhesion promoters. These samples and their uncoated controls were tested under standard WVTR (38° C. 90% Relative Humidity) and OTR test conditions (23° C. 0% Relative Humidity), with the coated side of the material to the conditions. As can be seen in the results below, in all cases the inclusion of the thin coating of film has increased the barrier properties of the film.

| | Adhesion Promoter | | Barrier Properties | |
|---|---|---|---|---|
| | | Ave Coating | OTR | WVTR |
| Film | | Thickness | cm³ m⁻² | g m⁻² |
| Type | Type | μm | day⁻¹ | day⁻¹ |
| PET | none | none | 42.4 | 14.5 |
| PET | 10% Type 1 & 10% | 1.7 | 37.7 | 13.1 |
| | Type 2 | | | |
| PP | none | none | 1200 | 2.6 |
| PP | 10% Type 1 & 10% | 3.3 | 400 | 2.7 |
| | Type 2 | | | |
| E167 | none | none | <0.2 | 4200 |
| E167 | none | 2.8 | <0.2 | 37.8 |
| E167 | 10% Type 1 | 2.1 | <0.2 | 22.1 |
| E167 | 10% Type 2 | 2.4 | <0.2 | 19 |

Alternate Adhesion Methods for Thin Films

Production of samples varied depending upon the adhesive type being tested. Samples with hot meltable adhesives were generated by passing the materials through a standard laminating machine with the adhesive layer in contact with the PVdC film in the middle of the sandwich. Those stuck to prepared adhesives or tapes were made by simple application of the material followed by a hand pressure smoothing over the surface.

Due to the thickness of the films, the materials were supported on a thin film of substrate 1 to which they were not strongly adhered. In all cases, the PVdC film was transferred from the film of substrate 1 to the “adhesive” coated film substrate and then the film of substrate 1 was removed so that the PVdC adhesion to the new substrate could be tested. Again, results of zero adhesion are due to competitive differences in adhesion between the adhesive on the film and that on our standard test tape.

The hot samples of PVdC film were cooled to room temperature before being analysed using a standard tape test to confirm adhesion. PVdC sample P1 was made using a blend of 85% Type 1 PVdC and 15% Type 2 PVdC and was approximately 4 μm thick, whilst PVdC film sample P2 was made using a medium viscosity PVdC and was approximately 3 μm thick.

| | | % PVdC Film Sample Residue | |
|---|---|---|---|
| | | after Tape Test | |
| | | P1 | |
| | | 4.2 micron | P2 |
| | | Pref. Low | 3.1 micron |
| Adhesive | Base | Visc PVdC | Med Visc |
| Type/Method | Film Type | blend | PVdC |

Lamination @ Heat 4

| | | | |
|---|---|---|---|
| EVA Hot Melt Adhesive | PP | 0 | 0 |
| Compostable Lamination | Substrate 1 | 70-100 | 90-100 |
| Adhesive | | | |

Lamination @ Heat 8

| | | | |
|---|---|---|---|
| EVA Hot Melt Adhesive | PP | 0 | — |
| Compostable Lamination | Substrate 1 | 85-100 | 90-100 |
| Adhesive | | | |

Tacky Surface @ RT

| | | | |
|---|---|---|---|
| High Tack Hot Melt PSA | PP | 90-100 | 80-100 |
| Cellulose Splicing | Substrate 1 | 90-100 | 90-100 |
| Adhesive Tape | | | |
| Scapa 1112 | | | |

Liquid Cyanoacrylate Adhesive

| | | | |
|---|---|---|---|
| CyanoAcrylate Adhesive | PP | 40-60% ^{#} | 40-60% ^{#} |
| CyanoAcrylate Adhesive | PET | 40-60% ^{#} | 40-60% ^{#} |
| CyanoAcrylate Adhesive | Substrate 2 | 40-60% ^{#} | 0 |

Note:
PSA = Pressure Sensitive Adhesive
Both PVdC films P1 & P2 are on a substrate 1/Support Film - negligible adhesion to substrate
^{#} Adhesive stuck PVdC Film to both carrier film and test material. When separated layers were stuck to both films, so adhesion to test film seemed to be between 40-60%.

### Example 5

### Adhesion Promotion by Post Heat Treatment of the Film

FIG. 4 shows a schematic diagram of a post-coated adhesion promoter system. A coated film 41, coated side up, is unwound from reel 42, before passing through a series of two 1 KW IR Heaters 43. The film 41 then passes a metal block 44 at 80° C., which acts as a radiant heater and then between a nip roller 45 and a metal chill roller 46 at 2 m/min. Throughout the process, the surface of the film 41 is heated to approximately 76-100° C. (measured using an IR thermal gun) using the bank of two IR heaters 43 and is then cooled by the chill roller 46, which was set at room temperature, before being wound up on a reel 47.

Samples created using the arrangement of FIG. 4 were checked to see what effect the post treatment had on adhesion, using a standard tape test. As can be seen in the results below, the effect of post treatment of samples is variable depending upon a range of conditions including the material thickness, type and thickness of adhesion promoter present, as well as the temperature reached (dependent upon heaters and the speed of the machine). In all cases, post heat treatment of the sample significantly improved the adhesion of the PVdC coating to the substrate film.

| | Film Tested | | | |
|---|---|---|---|---|
| | | PVdC + Adhesion | % Adhesion after Tape Test | |
| Adhesion | Film | Promoter Coating | Before | After |
| Promoter Type | Type | Thickness (microns) | Heating | Heating |
| 4% 7 | E167 | 3.5 | 0 | 0 |
| none | E167 | 2.5 | 0 | 0 |
| 10% 4 + 10% 5 | PP | 5.7 | 10 | 80 |
| 10% 4 + 10% 5 | PET | 3.4 | 20 | 80 |
| 10% 1 + 10% 2 | E167 | 1.8 | 20 | 100 |
| 10% 1 + 10% 2 | E167 | 2.2 | 20 | 40 |
| 10% 1 + 10% 4 | E167 | 1.6 | 2 | 40 |
| none | E167 | ~3 | 0 | 0 |
| 10% 2 | E167 | 2.2 | 0 | 2 |

1. A coated substrate comprising a substrate and an extrusion coated PVdC layer with a thickness of less than 10 micrometres.

2. A process for producing a coated substrate, comprising:
providing a substrate; and
applying a PVdC coating to the substrate by a hot melt coating step,
wherein the PVdC layer has a thickness of less than 10 micrometres.

3. The process of claim 2, wherein the hot melt coating step is an extrusion coating step.

4. The coated substrate of claim 1, wherein the PVdC layer has a thickness of less than 5 micrometres.

5. The coated substrate of claim 1, wherein the PVdC layer has a thickness of between 1 and 5 micrometres.

6. The coated substrate of claim 1, wherein the substrate is a film.

7. The coated substrate of claim 1, wherein the PVdC is one of (i) a copolymer of vinylidene chloride and vinyl chloride; (ii) a copolymer of vinylidene chloride and methyl acrylate; or (iii) a copolymer or terpolymer of vinylidene chloride, vinyl chloride and methyl acrylate or other suitable monomers or a compatible mixture or blend of two or more thereof.

8. The coated substrate of claim 1, wherein the relative viscosity of the PVdC extrusion blend is 1.45 or less.

9. The coated substrate of claim 1, wherein the substrate is a polyolefin or polyester film.

10. The coated substrate of claim 9, wherein the polyolefin film is an oriented polypropylene film, or PET.

11. The coated substrate of claim 1, wherein the substrate is a cast film.

12. The coated substrate of claim 1, wherein the substrate is a cellulosic film.

13. The coated substrate of claim 1, wherein the PVdC layer includes an adhesion promoter, selected from polyester, urethane isocyanate, epoxide, acrylic acid and derivatives thereof, and acrylate; and compatible mixtures or blends of two or more thereof.

14. The coated substrate of claim 13, wherein the adhesion promoter comprises a polyester or acrylate.

15. The coated substrate of claim 13, wherein the adhesion promoter is a migratory additive which in the final product predominantly resides at the boundary between the PVdC layer and the substrate.

16. The coated substrate of claim 1, wherein the PVdC layer is on the external surface of the substrate.

17. The coated substrate of claim 1, wherein the PVdC layer is not acting as a primer layer for a further polymeric layer or coating.

18. The coated substrate of claim 1, wherein the PVdC layer is applied to the substrate heated to temperatures of 50° C. or above.

19. The coated substrate of claim 1, wherein the PVdC layer is applied to the substrate heated to temperatures of 65° C. or above.

20. The coated substrate of claim 14, wherein the adhesion promoter is a migratory additive which in the final product predominantly resides at the boundary between the PVdC layer and the substrate.
